(19) United States
(12) Patent Application Publication
(10) Pub. No.: US 2018/0216037 A1
(43) Pub. Date: Aug. 2, 2018

(54) CONCENTRATED SURFACTANT COMPOSITION

(71) Applicant: The Procter & Gamble Company, Cincinnati, OH (US)

(72) Inventors: Mark William HAMERSKY, Hamilton, OH (US); John W. Semmel, III, Finneytown, OH (US); Mark Robert Sivik, Mason, OH (US); Paul R. MORT, III, Cincinnati, OH (US)

(21) Appl. No.: 15/880,579

(22) Filed: Jan. 26, 2018

Related U.S. Application Data
(60) Provisional application No. 62/451,110, filed on Jan. 27, 2017.

(51) Int. Cl. C11D 3/37; C11D 1/37; C11D 3/43

(52) U.S. Cl. CPC C11D 3/3723; C11D 1/29; C11D 3/43; C11D 1/37

(57) ABSTRACT

Concentrated surfactant compositions that include an alkyl alkoxylated sulfate surfactant and rheology modifier, and processes for making such compositions. Detergent compositions made from such concentrated surfactant compositions, and processes for making such detergent compositions.

### FIELD OF THE INVENTION

The present disclosure relates to concentrated surfactant compositions that include an alkyl alkoxylated sulfate surfactant and a rheology modifier, and processes for making such compositions. The present disclosure further relates to detergent compositions made from such concentrated surfactant compositions, and processes for making such detergent compositions.

### BACKGROUND OF THE INVENTION

Concentrated surfactant compositions are useful for making detergent compositions, such as laundry or dish detergent compositions. Because they have high activity, they can be transported relatively efficiently. Furthermore, they can be combined and diluted with other detergent ingredients or carriers to arrive at a desired level of activity in a liquid product. Additionally, such concentrated surfactant compositions may be mixed with other detergent ingredients with minimal drying to form a solid or semi-solid form in a powder or other solid dose-form product.

However, concentrated surfactant compositions, particularly those that contain a high proportion of anionic alkyl alkoxylated sulfate surfactant, may also present viscosity and/or stability challenges. The viscosity of such compositions may be relatively high, making the compositions difficult to pump or drain, for example from a rail car or from a storage tank to a manufacturing line. The compositions may also suffer from phase splits, which can lead to inconsistencies in the final product and/or aesthetic problems. Even upon dilution with water, concentrated compositions that include anionic alkyl alkoxylated sulfate surfactant may form a highly viscous hexagonal phase, which can be very challenging to process.

To counteract viscosity and/or stability issues, organic solvents may be added to the concentrated surfactant compositions. For example, low molecular weight polyethylene glycols (PEGs) of relatively low molecular weight (e.g., 4000) have historically been used to mitigate phase behavior challenge of making, processing and using highly concentrated surfactant compositions. However, organic solvents have little other function and may add cost without providing much performance benefit in the final product.

There is a need for improved concentrated surfactant compositions that have a relatively high level of activity, limited solvents levels, and desirable viscosity and/or phase stability.

### SUMMARY OF THE INVENTION

The present disclosure relates to a concentrated surfactant composition that includes: from about 70% to about 90%, by weight of the composition, of a surfactant system, the surfactant system including: from about 50% to about 100%, by weight of the surfactant system, of an anionic alkyl alkoxylated sulfate surfactant; from about 0.1% to about 25%, by weight of the composition, of a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof; no greater than about 5%, by weight of the composition, of non-aminofunctional organic solvent; and water.

The present disclosure also relates to a detergent composition that includes the concentrated surfactant composition as described herein, and a detergent adjunct.

The present disclosure also relates to a process for manufacturing a concentrated surfactant composition, the process including the steps of: providing an anionic alkyl alkoxylated sulfate surfactant, optionally an anionic sulfonated surfactant, a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof, optionally a non-aminofunctional organic solvent, and water; and combining the components in the following proportions to form the concentrated surfactant composition: a sufficient amount of the anionic alkyl alkoxylated sulfate surfactant, and optionally the anionic sulfonated surfactant, to form a surfactant system, where the surfactant system is present in an amount of from about 70% to about 90%, by weight of the composition, and where the anionic alkyl alkoxylated sulfate surfactant is present at a level of from about 50% to about 100%, by weight of the surfactant system; from about 0.1% to about 25%, by weight of the composition, of the rheology modifier; no greater than 5% non-aminofunctional organic solvent; and water.

The present disclosure also relates to a process for manufacturing a detergent composition, the process including the steps of: providing a concentrated surfactant composition as described herein; and combining the concentrated surfactant composition with a detergent adjunct to form the detergent composition.

The present disclosure also relates to a use of a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof, for reducing viscosity of a concentrated surfactant composition, where the composition includes from about 70% to about 90%, by weight of the composition, of a surfactant system; the surfactant system including from about 50% to about 100% of an anionic alkyl alkoxylated sulfate surfactant.

### DETAILED DESCRIPTION OF THE INVENTION

The present disclosure relates to concentrated surfactant compositions that contain a relatively high level of alkyl alkoxylated sulfate surfactant, such as alkyl ethoxylated sulfate surfactant (“AES”).

It has been surprisingly found that a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof can be added to the concentrated composition to provide viscosity and/or stability benefits, thereby enabling the level of organic solvent to be decreased. Such polymers are commonly used in final products, such as laundry detergents, in combination with AES and provide more performance benefits, such as cleaning benefits, than organic solvents do. Spiking the concentrated compositions, which may be relatively upstream in the manufacturing process, with these polymers enables the final product's activity level to remain relatively high without sacrificing formulation space or paying unnecessary cost.

The components and properties of the concentrated surfactant compositions of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein with regard to surfactants that may have an acid form, “neutralized” means that the surfactant is in salt form, such as a sodium salt. As used herein with regard to surfactants that may have an acid form, “preneutralized” means that the surfactant is in salt form prior to being combined with at least one other component of the disclosed compositions. The pH of such (pre)neutralized surfactants in a 10% aqueous solution may be about 7 or above.

As used herein, “isotropic” means a clear mixture (having no visible haziness and/or dispersed particles) and having a uniform transparent appearance. For example, the compositions of the present disclosure may be characterized by a % transmittance of greater than about 80%, or greater than about 90%, at a wavelength of 570 nm measured at room temperature via a standard 10 mm pathlength cuvette with a Beckman DU spectrophotometer using deionized water as blank, in the absence of dyes and/or opacifiers.

As used herein, the term “alkoxy” is intended to include C1-C8 alkoxy and C1-C8 alkoxy derivatives of polyols having repeating units such as butylene oxide, glycidol oxide, ethylene oxide or propylene oxide. The terms “ethylene oxide,” “propylene oxide” and “butylene oxide” may be shown herein by their typical designation of “EO,” “PO” and “BO,” respectively.

As used herein “average molecular weight” is reported as a weight average molecular weight, as determined by its molecular weight distribution; as a consequence of their manufacturing process, polymers disclosed herein may contain a distribution of repeating units in their polymeric moiety.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Concentrated Surfactant Composition

The present disclosure relates to concentrated surfactant compositions. The compositions described herein may be intermediate compositions intended to be combined with other ingredients to form a final product. The concentrated surfactant compositions of the present disclosures are sometimes considered to be surfactant pastes.

The concentrated surfactant compositions may comprise, may consist essentially of, or may consist of the following components: a surfactant system that may include an alkyl alkoxylated sulfate surfactant; a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof; an organic solvent system; and water. These components are described in more detail below.

The concentrated surfactant composition may comprise: from about 70% to about 90%, by weight of the composition, of a surfactant system, where the surfactant system comprises from about 50%, or from about 60%, or from about 70%, or from about 80%, to about 100%, of alkyl alkoxylated sulfate surfactant; from about 0.1% to about 25%, by weight of the composition, a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof; less than about 5%, by weight of the composition, of an organic solvent system; and water. In some or all cases, the composition may comprise no more than 2, or no more than 1, additional (active) ingredients, other than, for example, typical impurities such as unreacted reactants, by-product, or expected hydrolysis products.

The concentrated surfactant compositions may have a viscosity of less than about 3,000 cps, or less than about 2,000 cps, or less than about 1,500 cps, or less than about 1,000 cps, measured at 1000 s⁻¹ and 60° C. The concentrated surfactant compositions may have a viscosity of from about 10 cps, or from about 50 cps, or from about 100 cps, to about 3,000 cps, or to about 2,000 cps, or to about 1,500 cps, or to about 1,000 cps, measured at 1000 s⁻¹ and 60° C. Viscosities are determined according to the Shear Viscosity Test Method described herein, unless otherwise stated.

Having a relatively low viscosity may facilitate transporting, pumping, and/or processing the compositions. For example, viscosity of the concentrated composition may influence whether the composition is pumped out of a rail car via the top or bottom of the car. In a further example, the viscosity of the concentrated composition may influence processing of solid dose-form products, for example, agglomeration with detersive powders to make granular detergents.

It may be desirable for the concentrated surfactant composition to be phase stable and/or have a clear appearance, as such compositions may be easier to process and/or incorporate into a final product. The concentrated surfactant composition may be isotropic, which can be indicative of the composition being phase stable. The concentrated surfactant composition may remain as a single phase, isotropic solution after 2 weeks at 20° C., and/or 2 weeks at 40° C. The concentrated surfactant composition may have a percent transmittance (% T) at 570 nm of at least about 80%, or of at least about 85%, or of at least about 90%, or of at least about 95%, or of at least about 98%, or of at least about 99%. Percent transmittance is determined according to the Percent Transmittance method provided in the Test Methods section below.

The concentrated surfactant composition may have an alkaline pH in a 10% (weight/volume) solution of the composition at 20±2° C. The concentrated surfactant composition may be characterized by a pH greater than 8, or greater than 9, or greater than 10, or greater than 11, in a 10% (weight/volume) solution of the composition at 20±2° C. The concentrated surfactant composition may have a pH of from about 9 to about 13, or preferably from about 10 to about 13, in a 10% (weight/volume) solution of the composition at 20±2° C.

The concentrated surfactant composition may be characterized by a Reserve Alkalinity (RA) value. RA is a measure of the buffering capacity of the detergent composition (g/NaOH/100 g detergent composition) determined by titrating a 1% (w/v) solution of detergent composition with hydrochloric acid to pH 7.5 and is determined according to the method provided in the Test Methods section below. The concentrated surfactant composition may be characterized by a Reserve Alkalinity of less than about 2, or less than about 1.5, or less than about 1, or less than about 0.8. The concentrated surfactant composition may be characterized by a Reserve Alkalinity of from about 0.1, or from about 0.3, or from about 0.5, to about 2.0, or to about 1.5, or to about 1.0, or to about 0.8. Such Reserve Alkalinity can help to maintain the alkaline pH of the compositions described herein. Because alkyl alkoxylated sulfate surfactants can undergo acid-catalyzed hydrolysis reactions in acidic environments, it can be particularly desirable for compositions comprising such surfactants to have a certain Reserve Alkalinity.

The concentrated surfactant compositions of the present disclosure may remain as a single-phase solution after 2 weeks at 20° C., and/or 2 weeks at 40° C.

### Surfactant System

The concentrated surfactant compositions of the present disclosure comprise a surfactant system. The concentrated surfactant compositions may comprise from about 70% to about 90%, by weight of the composition, of a surfactant system.

The surfactant system may comprise anionic surfactant. The anionic surfactant of the surfactant system may comprise, or consist essentially of, alkyl alkoxylated sulfate surfactant, linear alkyl benzene sulfonate surfactant, or mixtures thereof. The surfactant system may be substantially free of nonionic surfactant, cationic surfactant, amphoteric surfactant, and/or zwitterionic surfactant. The surfactant system may be substantially free of nonionic surfactant.

The surfactant system may consist essentially of no more than two types of surfactants. It is recognized, however, that the surfactant system may include minor portions of, for example, raw material inputs, hydrolyzed reaction products, or other impurities related to the surfactants making up the major portion of the surfactant system, or other impurities.

The surfactants present in the surfactant system may be present either partially or completely in acid form or as a salt, typically a water-soluble salt. Suitable counterions include alkali metal cation, typically sodium, or ammonium or substituted ammonium, typically sodium. The surfactants, either separately or together, may be preneutralized prior to being combined with one or more of the other components of the concentrated surfactant system.

Alkyl Alkoxylated Sulfate

The surfactant system may comprise alkyl alkoxylated sulfate surfactant. The alkyl alkoxylated surfactant may be the major portion of the surfactant system. The alkyl alkoxylated surfactant may be linear, branched, or combinations thereof.

The alkyl alkoxylated sulfate surfactant may be present in the composition at a level of from about about 50%, or from about 60%, or from about 70%, or from about 80%, to about 100%, by weight of the surfactant system. The alkyl alkoxylated sulfate surfactant may be present at a level of from about 70% to about 90%, preferably from about 75% to about 85%, more preferably from about 77% to about 82%, by weight of the composition.

The alkyl alkoxylated sulfate surfactant may be an alkyl ethoxylated sulfate surfactant, an alkyl propoxylated surfactant, or mixtures thereof, preferably an alkyl ethoxylated sulfate surfactant. The alkyl alkoxylated sulfate surfactant may have a weight average degree of alkoxylation, preferably ethoxylation of from about 1 to about 3, more preferably from about 1 to about 2.5, even more preferably from about 1 to about 2.

When the alkyl alkoxylated sulfate surfactant is a mixture of alkyl alkoxylated sulfate surfactant, the alkoxylation degree is the weight average alkoxylation degree of all the components of the mixture (weight average alkoxylation degree). In the weight average alkoxylation degree calculation the weight of alkyl alkoxylated sulfate surfactant components not having alkoxylated groups should also be included. Weight average alkoxylation degree is calculated in the following manner:

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each sulfated anionic surfactant of the mixture and alkoxylation degree is the number of alkoxy groups in each sulfated anionic surfactant.

The alkyl alkoxylated sulfate surfactant may be alkyl ethoxylated surfactant having a narrow range of ethoxylation. The alkyl ethoxylated surfactant may include a distribution of alkyl ethoxylated surfactants where less than about 7% by weight of the total alkyl ethoxylated surfactant are alkyl ethoxylated surfactant having n≥3 and less than about 35% by weight of the total alkyl ethoxylated surfactant are alkyl ethoxylated surfactants having n=0, where n is the number of ethoxylates (EO) groups in the surfactant (AEₙS).

The alkyl alkoxylated sulfate may have a weight average alkyl chain length of from about 8 to about 18, or from about 10 to about 16 carbon atoms, preferably from about 12 to about 15 carbon atoms, even more preferably from about 14 to about 15 carbon atoms.

The alkyl alkoxylated sulfate may be alkyl ethoxylated surfactant having an average alkyl chain length of from about 14 to about 15 carbon atoms, and an average degree of ethoxylation of from about 1 to about 2.5. The alkyl alkoxylated sulfate may be C45 AE_{2.5}S, which has a weight average alkyl chain length of from 14 to 15 carbons and a weight average ethoxylation degree of 2.5. The alkyl alkoxylated sulfate may be C45 AE_{1.0}S, which has a weight average alkyl chain length of from 14 to 15 carbons and a weight average ethoxylation degree of about 1.0.

If the alkyl alkoxyalted sulfate is a branched alkyl alkoxylated sulfate, the branching group may be an alkyl group. The alkyl group may be selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. The branched alkyl alkoxylated sulfated anionic surfactant may be an alkyl ethoxy sulfates.

Alkyl alkoxylated sulfate surfactants are commercially available with a variety of chain lengths, ethoxylation and branching degrees. Commercially available sulfates include, those based on Neodol alcohols ex the Shell company, Lial—Isalchem and Safol ex the Sasol company, and natural alcohols ex The Procter & Gamble Chemicals Company.

Sulphonated Surfactant

The composition or surfactant system may further comprise an anionic sulphonated surfactant, preferably alkyl benzene sulphonate surfactant, more preferably linear alkyl benzene sulphonate (LAS) surfactant.

The sulphonated surfactant may be present at a level of from about 0% to about 50%, or from about 1% to about 50%, or from about 10% to about 40%, or from about 20% to about 35%, or from about 25% to about 30%, by weight of the composition. The sulphonated surfactant may be present at a level of from about 0%, or from about 1%, or from about 5%, or from about 10%, or from about 20%, or from about 25%, to about 50%, or to about 40%, or to about 35%, or to about 30%, by weight of the surfactant system. The sulfonated surfactant may be present at a level of from about 35% to about 45%, by weight of the surfactant system, and the alkyl alkoxylated sulfate may be present at a level of from about 55% to about 65%, by weight of the surfactant system.

The linear alkyl benzene sulphonate surfactant has a weight average alkyl chain length of from about 10 to about 16, preferably from about 11 to about 13, carbon atoms. The weight average alkyl chain length of the LAS may be about 11.8 carbons. The LAS may be present in acid form or as a salt, preferably as a sodium salt.

The weight ratio of AES to LAS in the surfactant system may be in the range of from about 99:1 to about 1:1, or from about 25:1 to about 1:1, or from about 10:1 to about 1.5:1, or from about 7:1 to about 2:1, or from about 5:1 to about 3:1. The weight ratio of AES to LAS in the surfactant system may be in the range of from about 2:1 to about 1:1.

The sulfonated surfactant may be present at a level of from about 35% to about 45%, by weight of the surfactant system, and the alkyl alkoxylated sulfate may be present at a level of from about 55% to about 65%, by weight of the surfactant system.

Suitable alkyl benzene sulphonate (LAS) is obtainable, and is preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as those catalyzed by hydrofluoric acid (HF), may also be suitable.

### Rheology Modifier

As used herein, the term “rheology modifier” means a material that interacts with concentrated surfactants, preferably concentrated surfactants having a mesomorphic phase structure, in a way that substantially reduces the viscosity and elasticity of said concentrated surfactant. Suitable rheology modifiers include, but are not limited to, sorbitol ethoxylate, glycerol ethoxylate, sorbitan esters, tallow alkyl ethoxylated alcohol, ethylene oxide-propylene oxide-ethylene oxide (EOx₁POyEOx₂) triblock copolymers wherein each of x₁ and x₂ is in the range of about 2 to about 140 and y is in the range of from about 15 to about 70, alkoxylated amines, alkoxylated polyamines, polyethyleneimine (PEI), alkoxylated variants of PEI, and preferably ethoxylated PEI, and mixtures thereof. The rheology modifier may comprise one of the polymers described above, for example, ethoxylated PEI, in combination with a polyethylene glycol (PEG) having a weight average molecular weight of about 2,000 Daltons to about 8,000 Daltons.

As used herein, the term “functional rheology modifier” means a rheology modifier that has additional detergent functionality. In some cases, a dispersant polymer, described herein below, may also function as a functional rheology modifier. A functional rheology modifier may be present in the composition at a level of from about 0.1% to about 25%, or from about 1% to about 20%, or from about 1% to about 15%, preferably from about 2% to about 12%, more preferably from about 4% to about 8% by weight of the composition.

### Alkoxylated Amine

The alkoxylated amine may be partially or fully protonated or not protonated across the pH range of the concentrated surfactant mixture. Alternatively, the alkoxylated amine may be partially or fully quaternized. The alkoxylated amine may be non-quaternized. The alkoxylated amine may comprise ethoxylate (EO) groups.

The alkoxylated amine may be linear, branched, or combinations thereof, preferably branched.

The alkoxylated amine may contain two or more amine moieties, such as N,N,N′,N′-Tetra(2-hydroxyethyl)ethylenediamine (also described as a type of hydroxylamine) N,N,N′,N′-Tetra(2-hydroxyethyl)ethylenediamine also functions as a chelant.

The alkoxylated amine may comprise (or be) an alkoxylated amine comprises an alkoxylated polyalkyleneimine. The alkoxylated polyalkyleneimine may be an alkoxylated polyethyleneimine (PEI).

Typically, the alkoxylated polyalkyleneimine polymer comprises a polyalkyleneimine backbone. The polyalkyleneimine may comprise C2 alkyl groups, C3 alkyl groups, or mixtures thereof, preferably C2 alkyl groups. The alkoxylated polyalkyleneimine polymer may have a polyethyleneimine (“PEI”) backbone.

The alkoxylated PEI may comprise a polyethyleneimine backbone having a weight average molecular weight of from about 400 to about 1000, or from about 500 to about 750, or from about 550 to about 650, or about 600, as determined prior to ethoxylation.

The PEI backbones of the polymers described herein, prior to alkoxylation, may have the general empirical formula:

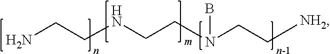

where B represents a continuation of this structure by branching. In some aspects, n+m is equal to or greater than 8, or 10, or 12, or 14, or 18, or 22.

The alkoxylated polyalkyleneimine polymer comprises alkoxylated nitrogen groups. The alkoxylated polyalkyleneimine polymer may independently comprise, on average per alkoxylated nitrogen, up to about 50, or up to about 40, or up to about 35, or up to about 30, or up to about 25, or up to about 20, alkoxylate groups. The alkoxylated polyalkyleneimine polymer may independently comprise, on average per alkoxylated nitrogen, at least about 5, or at least about 10, or at least about 15, or at least about 20, alkoxylate groups.

The alkoxylated polyalkyleneimine polymer, preferably alkoxylated PEI, may comprise ethoxylate (EO) groups, propoxylate (PO) groups, or combinations thereof. The alkoxylated polyalkyleneimine polymer, preferably alkoxylated PEI, may comprise ethoxylate (EO) groups. The alkoxylated polyalkyleneimine polymer, preferably alkoxylated PEI, may be free of propoxyate (PO) groups.

The alkoxylated amine, preferably the alkoxylated polyalkyleneimine polymer, more preferably alkoxylated PEI, may comprise on average per alkoxylated nitrogen, about 1-50 ethoxylate (EO) groups and about 0-5 propoxylate (PO) groups. The alkoxylated polyalkyleneimine polymer, preferably alkoxylated PEI, may comprise on average per alkoxylated nitrogen, about 1-50 ethoxylate (EO) groups and is free of propoxylate (PO) groups. The alkoxylated polyalkyleneimine polymer, preferably alkoxylated PEI, may comprise on average per alkoxylated nitrogen, about 10-30 ethoxylate (EO) groups, preferably about 15-25 ethoxylate (EO) groups.

Suitable polyamines include low molecular weight, water soluble, and lightly alkoxylated ethoxylated/propoxylated polyalkyleneamine polymers. By “lightly alkoxylated,” it is meant the polymers of this invention average from about 0.5 to about 20, or from 0.5 to about 10, alkoxylations per nitrogen. The polyamines may be “substantially noncharged,” meaning that there are no more than about 2 positive charges for every about 40 nitrogens present in the backbone of the polyalkyleneamine polymer at pH 10, or at pH 7; it is recognized, however, that the charge density of the polymers may vary with pH.

Suitable alkoxylated polyalkyleneimines, such as PEI600 EO20, are available from BASF (Ludwigshafen, Germany).

Ethylene Oxide-Propylene Oxide-Ethylene Oxide (EOx₁POyEOx₂) Triblock Copolymer

In the ethylene oxide-propylene oxide-ethylene oxide (EOx₁POyEOx₂) triblock copolymer, each of x₁ and x₂ is in the range of about 2 to about 140 and y is in the range of from about 15 to about 70. The ethylene oxide-propylene oxide-ethylene oxide (EOx₁POyEOx₂) triblock copolymer preferably has an average propylene oxide chain length of between 20 and 70, preferably between 30 and 60, more preferably between 45 and 55 propylene oxide units.

Preferably, the ethylene oxide-propylene oxide-ethylene oxide (EOx₁POyEOx₂) triblock copolymer has a weight average molecular weight of between about 1000 and about 10,000 Daltons, preferably between about 1500 and about 8000 Daltons, more preferably between about 2000 and about 7000 Daltons, even more preferably between about 2500 and about 5000 Daltons, most preferably between about 3500 and about 3800 Daltons.

Preferably, each ethylene oxide block or chain independently has an average chain length of between 2 and 90, preferably 3 and 50, more preferably between 4 and 20 ethylene oxide units.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂) triblock copolymer, where each of x₁ and x₂ is in the range of about 2 to about 140 and y is in the range of from about 15 to about 70, improve cleaning.

Preferably the copolymer has a weight average molecular weight between about 3500 and about 3800 Daltons, a propylene oxide content between 45 and 55 propylene oxide units, and an ethylene oxide content of between 4 and 20 ethylene oxide units per ethylene oxide block.

Preferably, the ethylene oxide-propylene oxide-ethylene oxide (EOx₁POyEOx₂) triblock copolymer has a weight average molecular weight of between 1000 and 10,000 Daltons, preferably between 1500 and 8000 Daltons, more preferably between 2000 and 7500 Daltons. Preferably, the copolymer comprises between 10% and 95%, preferably between 12% and 90%, most preferably between 15% and 85% by weight of the copolymer of the combined ethylene-oxide blocks. Some ethylene oxide-propylene oxide-ethylene oxide (EOx₁POyEOx₂) triblock copolymers, where each of x₁ and x₂ is in the range of about 2 to about 140 and y is in the range of from about 15 to about 70, improve dissolution.

Suitable ethylene oxide-propylene oxide-ethylene oxide triblock copolymers are commercially available under the Pluronic PE series from the BASF company, or under the Tergitol L series from the Dow Chemical Company. A particularly suitable material is Pluronic PE 9200.

### Non-Aminofunctional Organic Solvent

The concentrated surfactant compositions of the present disclosure may comprise a non-aminofunctional organic solvent. The organic solvent may contribute to desirable viscosity and stability profiles in the compositions of the present disclosure. However, it may be desirable to keep the amount of non-aminofunctional solvent at a minimum while still maintaining the desired viscosity and/or stability as the solvents add little to the performance benefits of the end product.

The concentrated surfactant compositions of the present disclosure may comprise no greater than about 5%, by weight of the composition, of non-aminofunctional organic solvent. The non-aminofunctional organic solvent may be present at a level of less than about 5%, or less than about 4%, or less than about 3%, preferably less than about 2%, preferably less than about 1%, preferably about 0%, by weight of the composition. The concentrated surfactant compositions may comprise from about 0% to about 55%, or from about 0% to about 1%, or about 0%, by weight of the composition, of the non-aminofunctional organic solvent.

The concentrated surfactant composition may be substantially free of a non-aminofunctional organic solvent.

The non-aminofunctional organic solvent, if present, may comprise at least one, or at least two, or at least three organic solvents. The non-aminofunctional organic solvent may comprise no more than four, or no more than three, or no more than two, or no more than one organic solvent.

The non-aminofunctional organic solvent, if present, may comprise a solvent selected from the group consisting of monohydric alcohols such as ethanol, propanol, butanol, isopropanol; dihydric alcohols such as diethylene glycol, propanediol, butanediol and diols wherein the hydroxyl groups present in said diol are attached to adjacent atoms; polyalkylene glycols such as polyethylene glycol; polyhydric alcohols such as glycerine; alkoxylated glycerine, alkoxylated diols, and combinations thereof. The non-aminofunctional organic solvent may comprise a solvent selected from the group consisting of: glycerine, ethanol, propanediol, diethylene glycol, dipropylene glycol, polyalkylene glycol (e.g., PEG4000), butanediol and combinations thereof.

The organic solvent system may comprise propanediol. The organic solvent system may comprise propanediol and at least one other organic solvent. The organic solvent system may comprise propanediol and diethylene glycol. The weight ratio of propanediol to diethylene glycol may be from about 1:2 to about 4:1. Alternatively, the organic solvent system may be substantially free of diethylene glycol.

The organic solvent system may comprise propanediol and ethanol. The weight ratio of propanediol to ethanol may be from about 1:1 to about 2.5:1, or from about 1.05:1 to about 2.11:1, or from about 1.5:1 to about 2.1:1.

### Water

The concentrated surfactant compositions of the present disclosure may contain water. The water can act as a solvent for the surfactant system in addition to the organic solvent system. When formulating the present concentrated compositions, some of the organic solvent system that might otherwise be necessary may be replaced by water. Water is typically present in at least some end detergent products, such as a heavy-duty liquid detergent composition, and typically costs less than organic solvent.

The concentrated surfactant compositions of the present disclosure may contain the components described herein (including surfactant system, organic solvent system, and alkalizing agent), with water to balance. The concentrated surfactant compositions of the present disclosure may comprise from about 5%, or from about 10%, to about 30%, or to about 25%, or to about 20%, or to about 16%, or to about 14%, by weight of the composition, of water.

Water may be added as free or neat water. In some aspects, water enters the composition as a component of other ingredients, for example, as a carrier of sodium hydroxide or organic acid. It is understood that water may also be formed from the neutralization of acids in the composition, for example, from acid-form alkyl ethoxylated sulfate (HAES) or acid-form LAS (HLAS).

### Alkalizing Agent

The concentrated surfactant compositions of the present disclosure may comprise an alkalizing agent. The concentrated surfactant compositions may comprise from about 0.1% to about 5.5% of the alkalizing agent. The alkalizing agent may be present in the concentrated surfactant composition at a level sufficient to neutralize the surfactants. When the surfactants are neutralized, whether they enter the composition preneutralized or are neutralized by the addition of the alkalizing agent, a small amount of excess alkalizing agent may be present in the composition, for example, from about 0.1% to about 1% by weight of the concentrated surfactant composition.

The alkalizing agent may be a caustic agent. Suitable caustic agents include alkali metal hydroxides, alkali earth metal hydroxides, ammonium (substituted or unsubstituted) hydroxides, or mixtures thereof. The alkalizing agent may be an alkali metal hydroxide, preferably sodium hydroxide.

The alkalizing agent may be an alkanolamine, such as monoethanolamine (MEA) or triethanolamine (TEA).

### Other Components

The concentrated surfactant compositions described herein, while typically being limited in the number of ingredients, may include other components as suitable. Suitable components may include a polymer, an antimicrobial agent, other surfactants (including branched anionic surfactants and/or amine oxide), hydrotropes (such as sodium cumene sulfate), fatty acid and/or salts thereof, or mixtures of any of the foregoing. The concentrated surfactant compositions herein may be substantially free of fatty acids, preferably free of carboxylic acids, and/or their salts.

### Detergent Compositions

The concentrated surfactant compositions of the present disclosure are useful for making detergent compositions. The detergent compositions may be intermediate compositions and/or end-use products intended to be sold to and used by consumers or institutions. Thus, the present disclosure also relates to detergent compositions. The detergent compositions of the present disclosure may comprise a concentrated surfactant composition, as described herein, and a detergent adjunct. The detergent composition may be a fabric care composition.

The detergent composition may have any form suitable for end use by a consumer, such as a liquid, a gel, a powder, a bar, a tablet, a unitized dose article such as a pouch (single- or multi-compartmented), a fiber, a web, or a sheet. The detergent composition may have a form selected from a liquid, a gel, one or more granules, one or more sheets, one or more fibers, or a combination thereof.

The detergent composition may comprise from about 5% to about 76%, or from about 8% to about 50%, or from about 10% to about 40%, by weight of the detergent composition, of the concentrated surfactant composition. The detergent composition may comprise a sufficient amount of the concentrated surfactant composition to provide about 5% to about 80%, or from about 8% to about 50%, or from about 10% to about 30%, by weight of the detergent composition, of surfactant to the detergent composition.

The detergent composition may comprise a detergent adjunct. Any suitable detergent adjunct may be added. The detergent adjunct may be selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

The detergent adjunct may comprise additional surfactant. Additional surfactants may be selected from anionic surfactants, nonionic surfactants, amphoteric surfactants, cationic surfactants, amphoteric surfactants, and combinations thereof. Suitable anionic surfactants may include additional LAS or branched anionic surfactants. Suitable nonionic surfactants may include ethoxylated alcohol surfactants. Suitable amphoteric surfactants may include amine oxide.

### Process for Manufacturing a Concentrated Surfactant Composition

The present disclosure relates to a process for manufacturing the concentrated surfactant composition disclosed herein. The steps may include the steps of: providing an anionic alkyl alkoxylated sulfate surfactant, optionally an anionic sulfonated surfactant, a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof, optionally a non-aminofunctional organic solvent, and water; and combining the components in the following proportions to form the concentrated surfactant composition: a sufficient amount of the anionic alkyl alkoxylated sulfate surfactant, and optionally the anionic sulfonated surfactant, to form a surfactant system, where the surfactant system is present in an amount of from about 70% to about 90%, by weight of the composition, and where the anionic alkyl alkoxylated sulfate surfactant is present at a level of from about 50% to about 100%, by weight of the surfactant system; from about 0.1% to about 25%, by weight of the composition, of the rheology modifier; no greater than 5% non-aminofunctional organic solvent; and water.

The process may include the steps of: providing an anionic alkyl alkoxylated sulfate surfactant, a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof, optionally a non-aminofunctional organic solvent, and water; and combining the components in the following proportions to form the concentrated surfactant composition: from about 70% to about 90%, by weight of the composition, of the anionic alkyl alkoxylated sulfate surfactant; from about 0.1% to about 10%, by weight of the composition, of the rheology modifier; no greater than 5% non-aminofunctional organic solvent; and water.

The process may include providing the alkyl alkoxylated sulfate surfactant and/or the linear alklyl benzene sulphonate surfactant in preneutralized form, preferably preneutralized with sodium (e.g., via sodium hydroxyide). The process may include the step of combining the alkyl alkoxylated sulfate surfactant and/or the linear alklyl benzene sulphonate surfactant with the alkalizing agent to preneutralize the surfactant(s) prior to combining with the organic solvent system. The alkalizing agent (e.g., sodium hydroxide) combined with the surfactant(s) may be at least about 50 wt % active, or at least about 60 wt % active, or at least about 70 wt % active. Higher active concentrations of alkalizing agent typically mean that smaller amounts of water are added to the concentrated surfactant compositions, leaving more formulation space for active ingredients (e.g., more surfactant) and/or other processing aids.

The composition may include a small excess of the alkalizing agent, preferably a caustic alkalizing agent such as sodium hydroxide, beyond what is required to neutralize the surfactants, whether or not they are provided as being preneutralized. Therefore, the concentrated surfactant composition may comprise from about 0.1% to about 1%, by weight of the concentrated surfactant composition, of an alkalizing agent, preferably a caustic alkalizing agent such as sodium hydroxide. It may be desirable to preneutralize the surfactants so that the pH can be more efficiently controlled.

The process according to the present disclosure for manufacturing a concentrated surfactant composition may include a step of removing moisture from an intermediate concentrated composition. Removing water may provide a more concentrated surfactant composition, resulting in transportation, processing, and/or product-making efficiencies. Water may be removed by any suitable method, such as with the use of a wet-film evaporator. Other removal methods may include, but are not limited to, distillation, rotary evaporation, sparging, and freeze drying. In the moisture removal step, the amount of water present in the intermediate composition compared to the amount of water present in the final concentrated surfactant composition may differ (e.g., decrease) by at least 5%, or at least 10%, or at least 20%, or at least 30%, or at least 40%, or at least 50%.

### Process for Manufacturing a Detergent Composition

The present disclosure relates to a process for manufacturing the detergent compositions. The detergent composition may have any form suitable as an intermediate detergent component or for an end-use by a consumer, such as a liquid, a gel, a powder, a bar, a tablet, a unitized dose article such as a pouch (single- or multi-compartmented), a fiber, a web, or a sheet.

The process may comprise the steps of: providing a concentrated surfactant composition as described herein and combining the concentrated surfactant composition with at least one adjunct to form a detergent composition.

The concentrated surfactant compositions of the present disclosure are useful as surfactant intermediates that may be incorporated into different end-use detergent compositions. Therefore, the present disclosure relates to a process for manufacturing a plurality of detergent compositions, the process comprising the steps of: providing a first portion of the concentrated surfactant composition as described herein; combining the first portion with first detergent adjuncts to form a first detergent composition; providing a second portion of the concentrated surfactant composition as described herein; combining the second portion with second detergent adjuncts to form a second detergent composition that is compositionally different from the first detergent composition. For the processes described herein, the concentrated surfactant composition may be provided at a single batch and then divided in to first and second portions, but does not need to be. The first and second portions could be provided as separate batches, manufactured as separate places or separate times.

The second detergent composition may be different from the first detergent compositions in terms of the adjuncts added, the relative proportions in which the adjuncts and/or concentrated surfactant composition were added, pH, aesthetics (including color and/or perfume), or any other suitable compositional difference.

### Use of a Rheology Modifier

The present disclosure further relates to the use of a rheology modifier as described above, preferably an alkoxylated polyalkyleneimine, for reducing viscosity of a concentrated surfactant composition, where the composition includes from about 70% to about 90%, by weight of the composition, of an anionic alkyl alkoxylated sulfate surfactant, preferably an anionic alkyl ethoxylated sulfate surfactant.

The present disclosure further relates to the use of a rheology modifier as described above, preferably an alkoxylated polyalkyleneimine, for reducing viscosity of a concentrated surfactant composition, where the composition includes from about 70% to about 90%, by weight of the composition, of a surfactant system, where the surfactant system comprising from about 50% to about 100% of an anionic alkyl alkoxylated sulfate surfactant. The surfactant system may further include from about 1% to about 50%, by weight of the surfactant system, of an anionic sulfonated surfactant, preferably an alkyl benzene sulfonate surfactant, more preferably a linear alkyl benzene sulfonate surfactant.

Suitable compositions and components thereof are described in more detail above.

### Combinations

Specifically, contemplated combinations of the disclosure are herein described in the following lettered paragraphs. These combinations are intended to be illustrative in nature and are not intended to be limiting.

A. A concentrated surfactant composition comprising: from about 70% to about 90%, by weight of the composition, of a surfactant system, the surfactant system comprising from about 50% to about 100% of an anionic alkyl alkoxylated sulfate surfactant; from about 0.1% to about 25%, by weight of the composition, of a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof; no greater than about 5%, by weight of the composition, of non-aminofunctional organic solvent; and water.

B. A concentrated surfactant composition according to paragraph B, wherein the rheology modifier is an alkoxylated amine that comprises ethoxylate (EO) groups, propoxylate (PO) groups, or combinations thereof, preferably ethoxylate (E0) groups.

C. A concentrated surfactant composition according to any of paragraphs A-B, wherein the alkoxylated amine comprises an alkoxylated polyalkyleneimine.

D. A concentrated surfactant composition according to any of paragraphs A-C, wherein the alkoxylated polyalkyleneimine comprises, on average per alkoxylated nitrogen, about 1-50 ethoxylate (EO) groups and about 0-5 propoxylate (PO) groups.

E. A concentrated surfactant composition according to any of paragraphs A-D, wherein the alkoxylated polyalkyleneimine comprises, on average per alkoxylated nitrogen, about 1-50 ethoxylate (EO) groups and is free of propoxylate (PO) groups.

F. A concentrated surfactant composition according to any of paragraphs A-E, wherein the alkoxylated polyalkyleneimine comprises, on average per alkoxylated nitrogen, about 10-30 ethoxylate (EO) groups, preferably about 15-25 ethoxylate (EO) groups.

G. A concentrated surfactant composition according to any of paragraphs A-F, wherein the alkoxylated polyalkyleneimine is an alkoxylated polyethyleneimine (PEI).

H. A concentrated composition according to any of paragraphs A-G, wherein the alkoxylated PEI comprises a polyethyleneimine backbone having a weight average molecular weight of from about 400 to about 1000, or from about 500 to about 750, or from about 550 to about 650, or about 600, as determined prior to ethoxylation.

I. A concentrated surfactant composition according to any of paragraphs A-H, wherein the alkoxylated amine is present at a level of from about 1% to about 15%, preferably from about 2% to about 12%, preferably from about 4% to about 8% by weight of the concentrated composition.

J. A concentrated surfactant composition according to any of paragraphs A-I, wherein the alkoxylated amine is non-quaternized.

K. A concentrated surfactant composition according to any of paragraphs A-J, wherein the alkyl alkoxylated sulfate surfactant is alkyl ethoxylated surfactant, preferably having an average degree of ethoxylation of from about 1 to about 3.5, more preferably from about 1 to about 3, even more preferably from about 1 to about 2.

L. A concentrated surfactant composition according to any of paragraphs A-K, wherein the alkyl alkoxylated sulfate has an average alkyl chain length of from about 10 to about 16 carbon atoms, preferably from about 12 to about 15 carbon atoms, even more preferably from about 14 to about 15 carbon atoms.

M. A concentrated surfactant composition according to any of paragraphs A-L, wherein composition comprises from about 75% to about 85%, preferably from about 77% to about 82%, by weight of the composition, of the surfactant system.

N. A concentrated surfactant composition according to any of paragraphs A-M, wherein the composition comprises less than 3%, preferably less than 2%, preferably less than 1%, preferably about 0%, by weight of the composition, of the non-aminofunctional organic solvent.

O. A concentrated surfactant composition according to any of paragraphs A-N, wherein the organic solvent is selected from the group consisting of: monohydric alcohols; dihydric alcohol; polyalkylene glycols; polyhydric alcohols; alkoxylated glycerine; alkoxylated diols; and combinations thereof.

P. A concentrated surfactant composition according to any of paragraphs A-O, wherein the organic solvent system comprises a solvent selected from the group consisting of: glycerine, ethanol, propanediol, diethylene glycol, dipropylene glycol, polyalkylene glycol, butanediol and combinations thereof.

Q. A concentrated surfactant composition according to any of paragraphs A-P, wherein the composition has a viscosity of less than about 3,000 cps, or from about 100 to about 2,000 cps, or from about 300 to about 1,500 cps, or from about 400 to about 1,000 cps when measured at 1000 s⁻¹ at 60° C., as determined according to the Shear Viscosity Test Method described herein.

R. A concentrated surfactant composition according to any of paragraphs A-Q, wherein the composition remains as a single-phase solution after 2 weeks at 20° C., and/or 2 weeks at 40° C.

S. A concentrated surfactant composition according to any of paragraphs A-R, wherein the composition is substantially free of fatty acids and/or salts thereof, preferably substantially free of carboxylic acids and/or salts thereof.

T. A concentrated surfactant composition according to any of paragraphs A-S, wherein the composition is characterized by an alkaline pH, preferably a pH greater than 8, or greater than 9, or greater than 10, or greater than 11 in a 10% (weight/volume) solution of the composition at 20±2° C.

U. A concentrated surfactant composition according to any of paragraphs A-T, wherein the composition is characterized has having a reserve alkalinity of less than about 2, or less than about 1.5, or less than about 1, or less than about 0.8.

V. A concentrated surfactant system according to any of paragraphs A-U, wherein the anionic alkyl alkoxylated sulfate surfactant is neutralized by a caustic agent, preferably a metal hydroxide, more preferably sodium hydroxide.

W. A concentrated surfactant composition according to any of paragraphs A-V, wherein the surfactant system further comprises from about 1% to about 50%, by weight of the surfactant system, of an anionic sulfonated surfactant, preferably alkyl benzene sulphonate surfactant, more preferably linear alkyl benzene sulphonate surfactant.

X. A concentrated surfactant composition according to any of paragraphs A-W, wherein the surfactant system comprises from about 10% to about 40%, preferably from about 20% to about 35%, by weight of the surfactant system, of the anionic sulphonated surfactant, preferably alkyl benzene sulphonate surfactant, more preferably linear alkyl benzene sulphonate surfactant.

Y. A detergent composition comprising the concentrated surfactant composition according to according to any of paragraphs A-X, and a detergent adjunct.

Z. A detergent composition according to paragraph Y, wherein the detergent adjunct is selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

AA. A detergent composition according to any of paragraphs Y-Z, wherein the detergent composition has a form selected from a liquid, a gel, a granule, a sheet, a fiber, or a combination thereof.

BB. A process for manufacturing a concentrated surfactant composition, the process comprising the steps of: providing an anionic alkyl alkoxylated sulfate surfactant, optionally an anionic sulfonated surfactant, a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof, optionally a non-aminofunctional organic solvent, and water; and combining the components in the following proportions to form the concentrated surfactant composition: a sufficient amount of the anionic alkyl alkoxylated sulfate surfactant, and optionally the anionic sulfonated surfactant, to form a surfactant system, where the surfactant system is present in an amount of from about 70% to about 90%, by weight of the composition, and where the anionic alkyl alkoxylated sulfate surfactant is present at a level of from about 50% to about 100%, by weight of the surfactant system; from about 0.1% to about 25%, by weight of the composition, of the rheology modifier; no greater than 5% non-aminofunctional organic solvent; and water.

CC. A process for manufacturing a detergent composition, the process comprising the steps of: providing a concentrated surfactant composition according to any of paragraphs A-X; and combining the concentrated surfactant composition with a detergent adjunct to form the detergent composition.

DD. A use of an alkoxylated polyalkyleneimine, preferably an alkoxylated polyalkyleneimine, for reducing viscosity of a concentrated surfactant composition, where the composition includes from about 70% to about 90%, by weight of the composition, of a surfactant system, where the surfactant system comprising from about 50% to about 100% of an anionic alkyl alkoxylated sulfate surfactant.

EE. A concentrated surfactant composition according to any of paragraphs A-X wherein said rheology modifier further comprises polyethylene glycol, wherein said polyethylene glycol has a weight average molecular weight from about 2000 to about 8000 Daltons.

FF. A concentrated surfactant composition according to any of paragraphs A-X wherein the ethylene oxide-propylene oxide-ethylene oxide (EOx₁POyEOx₂) triblock copolymer has an average propylene oxide chain length of between 20 and 70, preferably between 30 and 60, more preferably between 45 and 55 propylene oxide units.

GG. A concentrated surfactant composition according to any of paragraphs A-X wherein the ethylene oxide-propylene oxide-ethylene oxide (EOx₁POyEOx₂) triblock copolymer has a weight average molecular weight of between 1000 and 15,000 Daltons, preferably between 1500 and 5000 Daltons, more preferably between 2000 and 4500 Daltons, even more preferably between 2500 and 4000 Daltons, most preferably between 3500 and 3800 Daltons.

HH. A concentrated surfactant composition according to any of paragraphs A-X wherein each ethylene oxide block or chain of the ethylene oxide-propylene oxide-ethylene oxide (EOx₁POyEOx₂) triblock copolymer independently has an average chain length of between 2 and 90, preferably 3 and 50, more preferably between 4 and 20 ethylene oxide units.

II. A concentrated surfactant composition according to any of paragraphs A-X wherein the ethylene oxide-propylene oxide-ethylene oxide (EOx₁POyEOx₂) triblock copolymer comprises between 10% and 90%, preferably between 15% and 50%, most preferably between 15% and 25% by weight of the copolymer of the combined ethylene-oxide blocks.

JJ. A concentrated surfactant composition according to any of paragraphs A-X wherein the total ethylene oxide content of the ethylene oxide-propylene oxide-ethylene oxide (EOx₁POyEOx₂) triblock copolymer is equally split over the two ethylene oxide blocks, preferably each ethylene oxide block comprises on average between 40% and 60%, more preferably between 45% and 55%, even more preferably between 48% and 52%, most preferably 50% of the total number of ethylene oxide units, where the % of both ethylene oxide blocks adds up to 100%.

KK. A concentrated surfactant composition according to any of paragraphs A-X wherein the ethylene oxide-propylene oxide-ethylene oxide (EOx₁POyEOx₂) triblock copolymer has a weight average molecular weight between 3500 and 3800 Daltons, a propylene oxide content between 45 and 55 propylene oxide units, and an ethylene oxide content of between 4 and 20 ethylene oxide units per ethylene oxide block

### Test Methods

### Shear Viscosity Test Method

The Shear Viscosity Test Method is used to measure the shear viscosity of fluid specimens as a function of shear rate.

The viscosity test is conducted on a TA instruments Discovery HR-3 rheometer equipped with a 40 mm diameter parallel plate geometry and a Peltier plate is employed. The instrument is controlled via Trios software provided by TA instruments for this purpose. A nominal gap of 1.0 mm is used. The sample is placed on the center of the lower plate and then the upper plate is lowered and brought into contact with the material, while the gap is controlled to approx 1.0 mm. The excess material is then trimmed to ensure consistent sample volume. After the temperature equilibrates to 25° C. for 1 minute, the test ensues. The instrument is programmed to increase stress and measure the resulting viscosity stepwise. TA software calls this a Flow Sweep, and the process is carried out over a range of stress from low 0.1 Pa to high 1000 Pa in a logarithmic format (5 points per decade) using 5 sec. This test is conducted at 25° C., controlled via the Peltier plate temperature control unit used as the lower plate. The motor mode was set to auto in the Trios software, and the equilibration time and averaging time were set to 45 seconds and 15 seconds, respectively.

The test is completed once the upper stress limit is reached. At this point, the instrument stops and the user removes the specimen and cleans the fixture. The data are then plotted as viscosity (Pa-s) versus stress (Pa). Results are reported as the viscosity value measured at 1 Pa.

### Percent Transmittance

The Percent Transmittance is measured with a UV-Visible spectrometer such as a Beckman Coulter DU® 800. A standard 10 mm pathlength cuvette is used for the sample measurement and compared to a deionized water blank. Samples are measured in the in the absence of dyes and/or opacifiers, and at a temperature of 20° C.±2° C.

pH

Unless otherwise stated herein, the pH of the composition is defined as the pH of an aqueous 10% (weight/volume) solution of the composition at 20±2° C. Any meter capable of measuring pH to ±0.01 pH units is suitable. Orion meters (Thermo Scientific, Clintinpark-Keppekouter, Ninovesteenweg 198, 9320 Erembodegem-Aalst, Belgium) or equivalent are acceptable instruments. The pH meter should be equipped with a suitable glass electrode with calomel or silver/silver chloride reference. An example includes Mettler DB 115. The electrode should be stored in the manufacturer's recommended electrolyte solution.

The 10% aqueous solution of the detergent is prepared according to the following procedure. A sample of 10±0.05 grams is weighted with a balance capable of accurately measuring to ±0.02 grams. The sample is transferred to a 100 mL volumetric flask, diluted to volume with purified water (deionized and/or distilled water are suitable as long as the conductivity of the water is <5 μS/cm), and thoroughly mixed. About 50 mL of the resulting solution is poured into a beaker, the temperature is adjusted to 20±2° C. and the pH is measured according to the standard procedure of the pH meter manufacturer. The manufacturer's instructions should be followed to set up and calibrate the pH assembly.

### Reserve Alkalinity

As used herein, the term “reserve alkalinity” is a measure of the buffering capacity of the detergent composition (g/NaOH/100 g detergent composition) determined by titrating a 1% (w/v) solution of detergent composition with hydrochloric acid to pH 7.5 i.e in order to calculate Reserve Alkalinity as defined herein:

$$Reserve Alkalinity ( to pH 7.5 ) as \% alkali in g NaOH \text{/} 100 g product = \frac{T \times M \times 40 \times Vol}{10 \times Wt \times Aliquot}$$

T=titre (ml) to pH 7.5
M=Molarity of HCl=0.2
40=Molecular weight of NaOH
Vol=Total volume (ie. 1000 ml)
Wt=Weight of product (10 g)
Aliquot=(100 ml)

Obtain a 10 g sample accurately weighed to two decimal places, of fully formulated detergent composition. The sample should be obtained using a Pascall sampler in a dust cabinet. Add the 10 g sample to a plastic beaker and add 200 ml of carbon dioxide-free deionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls±1 ml aliquot using a 100 mls pipette immediately. Measure and record the pH and temperature of the sample using a pH meter capable of reading to ±0.01 pH units, with stirring, ensuring temperature is 21° C.+/−2° C. Titrate whilst stirring with 0.2M hydrochloric acid until pH measures exactly 7.5. Note the milliliters of hydrochloric acid used. Take the average titre of three identical repeats. Carry out the calculation described above to calculate RA to pH 7.5.

### EXAMPLES

The examples provided below are intended to be illustrative in nature and are not intended to be limiting. Ingredient levels are provided by weight %, unless otherwise indicated.

### Example 1. Process of Making a Concentrated Surfactant Composition

An ethoxylated alcohol is provided. The ethoxylated alcohol is sulfated by known processes including a sulfation reactor and a neutralization loop to form alkyl ethoxylated sulfate surfactant. In addition to the sulfated alcohol, the following are added in the neutralization loop while being mixed at high shear: optionally organic solvent, ethoxylated PEI, optionally water, and a neutralizing agent. The neutralization process is exothermic, thereby generating heat that is preferably removed by a heat exchanger in a recirculating neutralization loop. Due to the heat exchanger, the temperature may drop at least 5° C., or at least 10° C., for example dropping from about 70° C. to about 60° C. The effectiveness of the heat exchanger depends on the viscosity of the surfactant paste; if the viscosity is too high, the pressure drop across the heat exchanger can become excessive. Viscosity can be reduced by adding water; however, added water is undesired for making solid dose-form detergents. Alternatively, viscosity can be reduced by adding ethoxylated PEI in the neutralization loop; this enables neutralization of pastes with minimal moisture content.

Alternatively or additionally, ethoxylated PEI may instead be added after the neutralization loop, with an additional high shear mixing step. The ethoxylated PEI may be added as a concentrated aqueous solution, e.g., about 80% solids concentration, or as a substantially anhydrous liquid hot melt.

Water may be further removed from the paste composition, either within or after the neutralization loop, for example, using a wet-film evaporator.

### Example 2. Viscosities of Concentrated Surfactant Pastes

The viscosities of several concentrated surfactant paste compositions are measured; some of the pastes may be used to make particles according to the present disclosure and some may be used to make comparative particles.

Making of Surfactant Pastes:

The surfactant paste compositions are made as follows: the selected rheology modifier and water are added to a scintillation vial and mixed until the rheology modifier is fully dissolved to form a rheology modifier solution; the rheology modifier solution is combined with an ethoxylated alkyl sulphate (AES) solution (AES dissolved in water to the desired concentration, e.g., 21.95%), and sodium carbonate and mixed using a speed mixer cup—mixed for 30 seconds in the FlakTek DAC 500 speedmixer at 3500 rpm; the mixture is then transferred to a glass jar and allowed to stand for 24 hours, to de-gas the mixture.

In the example below, 69.2 g of an AES solution (21.95% active) is added to 8.1 g of a PEG 4000 solution (30% active, PEG 4000 dissolved in water to give 30% activity) and 2.8 g of sodium carbonate. The actual weight fraction of each material is tabulated in the rightmost column

PEG4000/AE1.8S/Sodium Carbonate
Batch Size 80.0 (g)

| | Chemical Name | Activity % | Formula % | Amount Needed (g) | Amount Added (g) | Actual % |
|---|---|---|---|---|---|---|
| | DI Water | 100.00% | 74.50% | 0.0 | 0.0 | |
| | PEG 4000 | 30.00% | 3.00% | 8.0 | 8.1 | 3% |
| | solution | | | | | |
| | AE1.8S solution | 21.95% | 19.00% | 69.2 | 69.2 | 19% |
| | Sodium | 100.00% | 3.50% | 2.8 | 2.8 | 4% |
| | Carbonate | | | | | |
| Total | | | | 80.0 | 80.1 | |

The shear viscosity of each paste is measured using The Shear Viscosity Test Method described herein and the viscosity is reported as an average of values taken at low stress. The shear viscosities are shown in the table below. Rheology modifiers marked with an asterisk (*) are shown to reduce viscosity, however these rheology modifiers generally do not provide detergent functionality.

| | | Viscosity |
|---|---|---|
| Rheology modifier (RM) | Paste formulation | Pa-s at 1 Pa |
| None | 21.10% AES, 4% Na₂CO₃ | 145 |
| None | 19% AES, 6% Na₂CO₃ | 93.7 |
| acrylic acid/maleic acid copolymer | 19% AES, 3% RM, 3.50% Na₂CO₃ | 172 |
| Sorbitol | 19% AES, 3% RM, 3.50% Na₂CO₃ | 91.3 |
| Polyethylene Glycol (PEG) 4000* | 19% AES, 3% RM, 3.50% Na₂CO₃ | 0.045 |
| Sodium Toluene Sulfonate (STS)* | 19% AES, 3% RM, 3.50% Na₂CO₃ | 0.11 |
| N,N,N′,N′-Tetra(2- | 19% AES, 3% RM, 3.50% Na₂CO₃ | 7.9 |
| hydroxyethyl)ethylenediamine | | |
| PE20¹ | 19% AES, 3% RM, 3.50% Na₂CO₃ | 0.14 |
| Pluronic F38² | 19% AES, 3% RM, 3.50% Na₂CO₃ | 0.03 |
| Tween 20³ | 19% AE1.8S solution, 3% RM, 3.50% Na₂CO₃ | 0.067 |
| Pluronic F68³ | 19% AE1.8S solution, 3% RM, 3.50% Na₂CO₃ | 0.07 |
| Pluronic L92³ | 19% AE1.8S solution, 3% RM, 3.50% Na₂CO₃ | 0.2 |
| Pluronic F77³ | 19% AE1.8S solution, 3% RM, 3.50% Na₂CO₃ | 0.099 |

¹an ethoxylated polyethyleneimine (polyethyleneimine (600 MW), average 20 ethoxylates per NH)
²difunctional block copolymer terminating in primary hydroxyl groups
³polysorbate 20

| | | | | | Value |
|---|---|---|---|---|---|
| | Weight | MW | | Value of X | of Y |
| | Percent | PO | Approximate | XEO-YPO- | XEO- |
| Material | EO Chain | Chain | MW | XEO | YPO-XEO |
| Pluronic F77 | 70 | 2050 | 2050 | | |
| Pluronic L92 | 20 | 2850 | 3650 | 8 | 50 |
| Pluronic F38 | 80 | 950 | 4700 | 43 | 16 |
| Pluronic F68 | 80 | 1750 | 8400 | 76 | 29 |

### Example 3. Concentrated Surfactant Paste Comprising Anionic Surfactant and Rheology Modifier

The following table shows sample formulations of concentrated surfactant compositions. Amounts are provided as weight percent, by weight of the composition. Ingredients include: AES=alkoxylated alkyl sulphate anionic detersive surfactant, sodium neutralized; LAS=alkyl benzene sulphonate surfactant, sodium-neutralized; rheology modifier=PE20, an ethoxylated polyethyleneimine; Misc includes excess alkalinity, salts and unreacted alcohol.

| Paste | | | | | | |
|---|---|---|---|---|---|---|
| com- | | | Total | rheology | | |
| position | AES | LAS | surfactant | modifier | Misc | Moisture |
| 1 | 74.5% | 0.0% | 74.5% | 7.5% | 4.0% | 14.0% |
| 2 | 78.0% | 0.0% | 78.0% | 11.7% | 4.1% | 6.2% |
| 3 | 72.0% | 0.0% | 72.0% | 18.0% | 3.8% | 6.2% |
| 4 | 66.7% | 11.3% | 78.1% | 3.3% | 3.8% | 14.8% |
| 5 | 70.1% | 11.9% | 82.0% | 7.0% | 4.0% | 7.0% |
| 6 | 65.0% | 11.0% | 76.0% | 13.0% | 3.7% | 7.3% |
| 7 | 58.5% | 15.8% | 74.3% | 6.9% | 3.7% | 15.2% |
| 8 | 57.8% | 15.6% | 73.4% | 7.8% | 3.7% | 15.1% |
| 9 | 61.8% | 16.7% | 77.5% | 7.3% | 3.9% | 10.3% |
| 10 | 61.0% | 16.5% | 78.5% | 8.2% | 3.9% | 10.4% |
| 11 | 57.0% | 18.8% | 75.8% | 5.7% | 3.5% | 15.0% |
| 12 | 63.2% | 20.8% | 84.0% | 6.3% | 3.8% | 5.9% |
| 13 | 61.3% | 20.2% | 81.5% | 9.2% | 3.7% | 5.6% |
| 14 | 52.6% | 26.3% | 78.8% | 2.1% | 3.4% | 15.7% |
| 15 | 57.3% | 28.7% | 86.0% | 4.6% | 3.7% | 5.7% |
| 16 | 56.0% | 28.0% | 84.0% | 6.7% | 3.6% | 5.7% |
| 17 | 47.7% | 31.9% | 79.6% | 1.4% | 3.3% | 15.7% |
| 18 | 52.1% | 34.9% | 87.0% | 3.1% | 3.6% | 6.3% |
| 19 | 50.9% | 34.1% | 85.0% | 5.1% | 3.5% | 6.4% |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A concentrated surfactant composition comprising:
from about 70% to about 90%, by weight of the composition, of a surfactant system, the surfactant system comprising from about 50% to about 100% of an anionic alkyl alkoxylated sulfate surfactant;
from about 0.1% to about 25%, by weight of the composition, of a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x2 is in the range of about 2 to about 140 and y is in the range of from about 15 to about 70, and mixtures thereof;
no greater than about 5%, by weight of the composition, of non-aminofunctional organic solvent; and
water.

2. A concentrated surfactant composition according to claim 1, wherein the alkoxylated amine comprises ethoxylate (EO) groups, propoxylate (PO) groups, or combinations thereof, preferably ethoxylate (EO) groups.

3. A concentrated surfactant composition according to claim 1, wherein the alkoxylated amine is N,N,N′,N′-tetra(2-hydroxyethyl)ethylenediamine.

4. A concentrated surfactant composition according to claim 1, wherein the alkoxylated amine comprises an alkoxylated polyalkyleneimine, preferably the alkoxylated polyalkyleneimine comprises, on average per alkoxylated nitrogen, about 1-50 ethoxylate (EO) groups and about 0-5 propoxylate (PO) groups, more preferably the alkoxylated polyalkyleneimine comprises, on average per alkoxylated nitrogen, about 1-50 ethoxylate (EO) groups and is free of propoxylate (PO) groups.

5. A concentrated surfactant composition according to claim 3, wherein the alkoxylated polyalkyleneimine comprises, on average per alkoxylated nitrogen, about 10-30 ethoxylate (EO) groups, preferably about 15-25 ethoxylate (EO) groups.

6. A concentrated surfactant composition according to claim 3, wherein the alkoxylated polyalkyleneimine is an alkoxylated polyethyleneimine (PEI), preferably the alkoxylated PEI comprises a polyethyleneimine backbone having a weight average molecular weight of from about 400 to about 1000, or from about 500 to about 750, or from about 550 to about 650, or about 600, as determined prior to ethoxylation.

7. A concentrated surfactant composition according to claim 1, wherein the rheology modifier is present at a level of from about 1% to about 15%, preferably from about 2% to about 12%, preferably from about 4% to about 8% by weight of the concentrated composition.

8. A concentrated surfactant composition according to claim 1 wherein the alkoxylated amine is non-quaternized.

9. A concentrated surfactant composition according to claim 1, wherein the alkyl alkoxylated sulfate surfactant is alkyl ethoxylated surfactant, preferably having an average degree of ethoxylation of from about 1 to about 3.5, more preferably from about 1 to about 3, even more preferably from about 1 to about 2.

10. A concentrated surfactant composition according to claim 1, wherein the alkyl alkoxylated sulfate has an average alkyl chain length of from about 10 to about 16 carbon atoms, preferably from about 12 to about 15 carbon atoms, even more preferably from about 14 to about 15 carbon atoms.

11. A concentrated surfactant composition according to claim 1, wherein composition comprises from about 75% to about 85%, preferably from about 77% to about 82%, by weight of the composition, of the surfactant system.

12. A concentrated surfactant composition according to claim 1, wherein the composition comprises less than 3%, preferably less than 2%, preferably less than 1%, preferably about 0%, by weight of the composition, of the non-aminofunctional organic solvent.

13. A concentrated surfactant composition according to claim 1, wherein the organic solvent is selected from the group consisting of: monohydric alcohols; dihydric alcohol; polyalkylene glycols; polyhydric alcohols; alkoxylated glycerine; alkoxylated diols; and combinations thereof.

14. A concentrated surfactant composition according to claim 1, wherein the organic solvent system comprises a solvent selected from the group consisting of: glycerine, ethanol, propanediol, diethylene glycol, dipropylene glycol, polyalkylene glycol, butanediol and combinations thereof.

15. A concentrated surfactant composition according to claim 1, wherein the composition has a viscosity of less than about 3,000 cps, or from about 100 to about 2,000 cps, or from about 300 to about 1,500 cps, or from about 400 to about 1,000 cps when measured at 1000 s⁻¹ at 60° C., as determined according to the Shear Viscosity Test Method described herein.

16. A concentrated surfactant composition according to claim 1, wherein the composition remains as a single-phase solution after 2 weeks at 20° C., and/or 2 weeks at 40° C.

17. A concentrated surfactant composition according to claim 1, wherein the composition is substantially free of fatty acids and/or salts thereof, preferably substantially free of carboxylic acids and/or salts thereof.

18. A concentrated surfactant composition according to claim 1, wherein the composition is characterized by an alkaline pH, preferably a pH greater than 8, or greater than 9, or greater than 10, or greater than 11 in a 10% (weight/volume) solution of the composition at 20±2° C.

19. A concentrated surfactant composition according to claim 1, wherein the composition is characterized has having a reserve alkalinity of less than about 2, or less than about 1.5, or less than about 1, or less than about 0.8.

20. A concentrated surfactant system according to claim 1, wherein the anionic alkyl alkoxylated sulfate surfactant is neutralized by a caustic agent, preferably a metal hydroxide, more preferably sodium hydroxide.

21. A concentrated surfactant composition according to claim 1, wherein the surfactant system further comprises from about 1% to about 50%, preferably from about 10% to about 40%, more preferably from about 20% to about 35%, by weight of the surfactant system, of an anionic sulfonated surfactant, preferably alkyl benzene sulphonate surfactant, more preferably linear alkyl benzene sulphonate surfactant.

22. A detergent composition comprising the concentrated surfactant composition according to claim 1, and a detergent adjunct, preferably the detergent adjunct is selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

23. A detergent composition according to claim 22, wherein the detergent composition has a form selected from a liquid, a gel, a granule, a sheet, a fiber, or a combination thereof.

24. A process for manufacturing a concentrated surfactant composition, the process comprising the steps of:
providing an anionic alkyl alkoxylated sulfate surfactant, optionally an anionic sulfonated surfactant, a rheology modifier selected from the group consisting an alkoxylated amine, preferably an alkoxylated polyamine, more preferably a quaternized or non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof, optionally a non-aminofunctional organic solvent, and water; and
combining the components in the following proportions to form the concentrated surfactant composition:
a sufficient amount of the anionic alkyl alkoxylated sulfate surfactant, and optionally the anionic sulfonated surfactant, to form a surfactant system,
where the surfactant system is present in an amount of from about 70% to about 90%, by weight of the composition, and
where the anionic alkyl alkoxylated sulfate surfactant is present at a level of from about 50% to about 100%, by weight of the surfactant system;
from about 0.1% to about 25%, by weight of the composition, of the rheology modifier;
no greater than 5% non-aminofunctional organic solvent; and
water.

25. A process for manufacturing a detergent composition, the process comprising the steps of:
providing a concentrated surfactant composition according to claim 1; and
combining the concentrated surfactant composition with a detergent adjunct to form the detergent composition.

26. A concentrated surfactant composition according to claim 1 wherein the rheology modifier is selected from the group consisting of non-quaternized alkoxylated polyethyleneimie having an empirical formula (I) of (PEI)a-(EO)b-R₁, wherein a is in the range of from about 100 to about 1000 Daltons, preferably 600 Daltons, wherein b is in the range of from about 10 to about 25, preferably about 20, and wherein R₁ is independently selected from the group consisting of hydrogen, C₁-C₄ alkyl, and combinations thereof, an ethylene oxide-propylene oxide-ethylene oxide (EOx₁POyEOx₂) triblock copolymer, wherein each of x₁ and x₂ is in the range of about 2 to about 140 and y is in the range of from about 15 to about 70, and N,N,N′,N′-tetraethoxylethylenediamine.
